(19) United States
(12) Patent Application Publication
(10) Pub. No.: US 2004/0107916 A1
(43) Pub. Date: Jun. 10, 2004

(54) Cage

(76) Inventor: Yohiki Takimoto, Yamabe-gun (JP)

Correspondence Address: Joseph W. Price, SNELL & WILMER LLP, Suite 1200, 1920 Main Street, Irvine, CA, 92614-7230, US

(21) Appl. No.: 10/723,882

(22) Filed: Nov. 26, 2003

(30) Foreign Application Priority Data
Dec. 4, 2002 (JP) 2002-352568

(51) Int. Cl. A01K 1/02; A01K 1/03; A01K 31/06

(52) U.S. Cl. 119/474

(57) ABSTRACT

The present invention provides a cage which can be assembled easily and disassembled in a compact manner.

The present invention is a cage, which comprises a cage main body having a side wall and a roof and a mount for supporting the cage main body, being constituted in such that the side wall includes a plurality of nets with a bent or curved portion and a plurality of plates with their right and left end portions connected to the right and left end portions of the nets, and the right and left end portions of the connected nets are substantially flush with the right and left end portions of the plates.

### BACKGROUND OF THE INVENTION

1. Field of the Invention

The present invention relates to a cage used for raising small animals such as birds, squirrels, hamsters and mice.

2. Description of the Related Art

A conventional cage comprises a cage main body having a roof with a substantially rectangular configuration as seen from above and a side wall connected to the roof and a mount for supporting the cage main body. The side wall is formed of four substantially rectangular nets, and the right and left end portions of the nets are connected together.

In accordance with such cage, however, the end portions of the nets must be connected together so that the nets form an angle of 90°. It is difficult to mount two nets to the mount while held by the hand so that the aforementioned angle is not changed. Thus, there arises a problem that it takes labor and time to assemble the cage.

As disclosed in Japanese Patent Application Laid-Open (JP-A) No. 2003-125663, another cage comprises a cage main body having a side wall and a roof and a mount for supporting the cage main body. The side wall is formed of two nets with a substantially U-shaped configuration as seen from above, each of which is consisted of a substantially rectangular central portion and two rectangular portions connected to the right and left portions of the central portion so as to be bent by about 90°. The right and left end portions of the two nets are connected together so that an angle of 180° is formed thereby.

In accordance with this cage with the above-described structure, the right and left end portions of the connected two nets are substantially flush with each other. Thus, the following advantages can be provided. Namely, it is possible to mount the two nets to the mount relatively easily while held by the hand so that the angle formed by the nets is not changed. Further, the cage can be assembled rapidly.

In accordance with the cage with the above-described structure, however, the width of the two rectangular portions of the net is large. Thus, there arises a problem in that the cage cannot be disassembled in a compact manner when it is transported or put away because the two nets are bulky.

The present invention was developed in view of the aforementioned problems and an object of the present invention is to provide a cage which can be assembled easily and disassembled in a compact manner.

### SUMMARY OF THE INVENTION

In order to accomplish the aforementioned object, a cage of the present invention comprises a cage main body having a side wall and a roof and a mount for supporting the cage main body. The side wall includes a plurality of nets with a bent or curved portion and a plurality of plates with their right and left end portions connected to the right and left end portions of the nets. The right and left end portions of the connected nets are substantially flush with the right and left end portions of the plates (claim 1).

Further, two nets are provided and each of them is formed in a substantially U-shaped configuration as seen from above (claim 3).

In accordance with such cage with the above-described structure, that portion of the side wall that needs to be bent (or curved) by a predetermined angle is provided only at the net. The right and left end portions of the connected nets are substantially flush with the right and left end portions of the plates. Thus, it is possible to mount the net and the plate to the mount relatively easily while held by the hand so that the angle formed by the net and the plate is not changed. As a result, the cage can be assembled rapidly and easily.

Instead of directly connecting the nets together, the nets are connected via the plates. The width of short rectangular portions of the net with the substantially U-shaped configuration as seen from above (which will be described later) can be reduced. As a result, the net is not bulky and thus the cage can be disassembled in a compact manner when it is transported or put away.

The plate may be formed of materials with light transmitting property (claim 2).

### BRIEF DESCRIPTION OF THE DRAWINGS

FIG. 1 is an exploded perspective view schematically illustrating the structure of a cage relating to one embodiment of the present invention;

FIG. 2 is an exploded perspective view schematically illustrating the structure of the main portion of the embodiment;

FIG. 3 is a vertical sectional view schematically illustrating the structure of the main portion of the embodiment;

FIG. 4A is a perspective view schematically illustrating the structure of a plate relating to the embodiment;

FIG. 4B is a horizontal sectional view schematically illustrating the structure of the plate relating to the embodiment;

FIG. 5A is a perspective view schematically illustrating the structure of modified example of the plate;

FIG. 5B is a vertical sectional view schematically illustrating the structure of the modified example of the plate;

FIG. 5C is an explanatory view schematically illustrating the structure of the modified example of the plate; and

FIG. 6 is a perspective view schematically illustrating the structure of another modified example of the plate.

### DETAILED DESCRIPTION OF THE PREFERRED EMBODIMENTS

Embodiments of the present invention will be described hereinafter on the basis of the drawings.

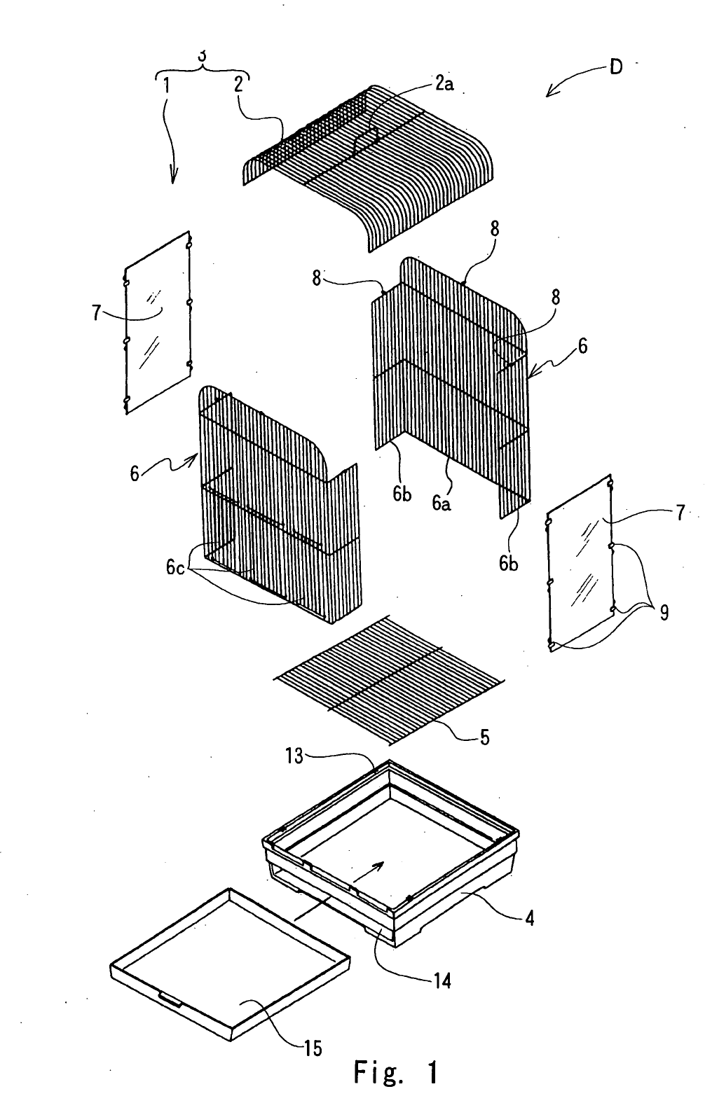

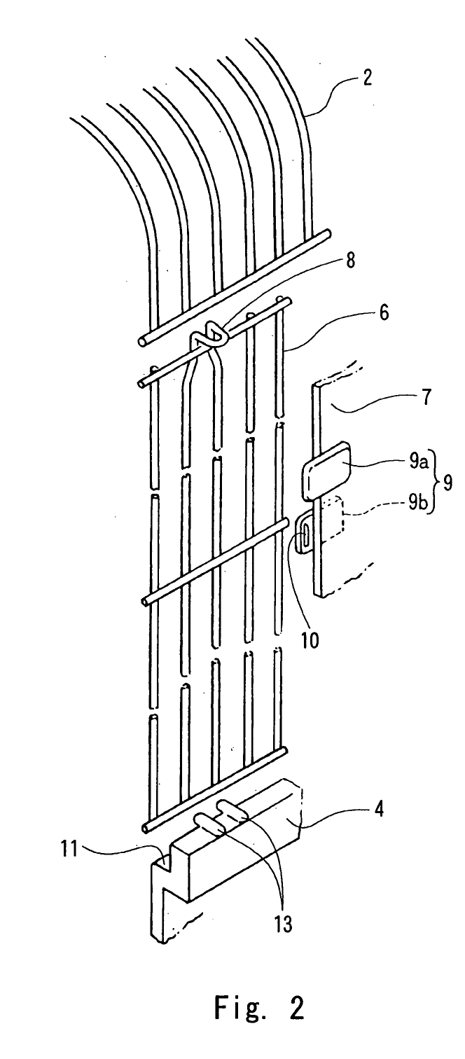

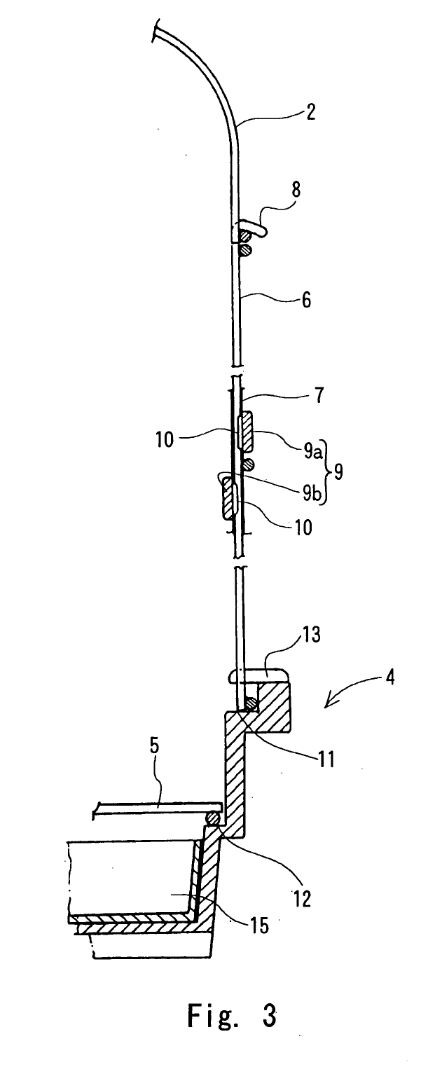

FIG. 1 is an exploded perspective view schematically illustrating the structure of a cage D relating to one embodiment of the present invention. FIG. 2 is an exploded perspective view schematically illustrating the structure of main portion of the cage D. FIG. 3 is a vertical sectional view schematically illustrating the structure of main portion of the cage D.

The cage D comprises a cage main body 3 which has a side wall 1 and a roof 2, a mount 4 which supports the cage main body 3 and a bottom net 5 which is placed within the mount 4.

The side wall 1 includes a plurality of (two in this embodiment) nets 6, 6 each of which is provided with a bent or curved portion and two plates 7, 7 whose right and left end portions are connected to the right and left end portions of the nets 6, 6. Further, the side wall 1 is configured so that the connected right and left end portions of the plate 7 are substantially flush with the right and left end portions of the net 6.

The net 6 is formed in a substantially U-shaped configuration as seen from above and includes a substantially rectangular shaped central portion 6a and short rectangular portions 6b, 6b connected to the right and left sides of the central portion 6a so as to be bent by about 90°.

The upper portion of the central portion 6a is protruded even further upward as compared to the upper end portions of the short rectangular portions 6b, 6b. The right and left end portions of the upper portion of the central portion 6a are cut away in a curved manner.

Pawl-shaped engagement devices 8 protruding outwardly are provided on the upper end portions of the central portion 6a and the short rectangular portions 6b, 6b.

A plurality of (three in this embodiment) doors 6c opened or closed by being vertically slid are provided at the central portion 6a of one of the two nets 6, 6. Instead of being provided only at the central portion 6a of one net 6, the doors 6c may be provided at the short rectangular portion 6b or may be provided at another net 6. The door 6c is not limited to such a door opened or closed by being vertically slid.

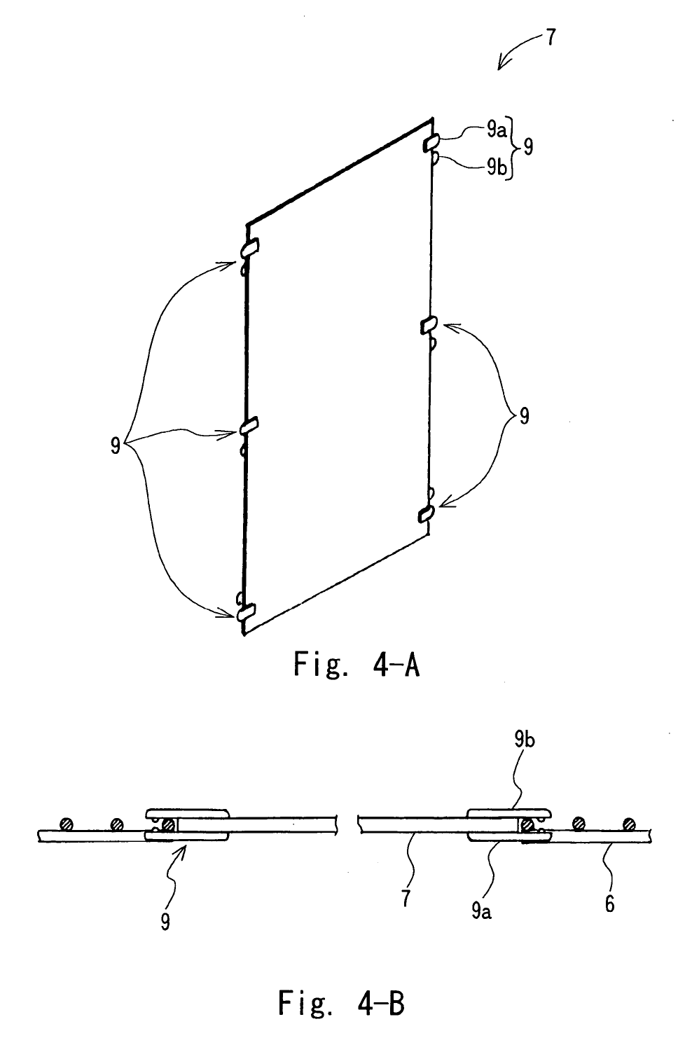

FIG. 4A is a perspective view schematically illustrating the structure of the plate 7. FIG. 4B is a horizontal sectional view schematically illustrating the structure of the plate 7.

The plate 7 is made of a plastic resin with light transmitting property, e.g., acrylonitrile styrene (AS) or polystyrene (PS). In accordance with this embodiment, the plate 7 is formed so as to be substantially transparent or semi-transparent. For example, the plate 7 may be formed so as to be substantially semi-transparent. Further, the plate 7 is formed in a substantially rectangular flat plate. Moreover, its peripheral edge portion is provided with joint portions 9 connected to the right and left end portions of the net 6.

The joint portions 9 are provided on the peripheral edge portion of the plate 7 (the right end left edge portions of the plate 7 in this embodiment). Each of the joint portions 9 is formed of protruded members 9a, 9b protruding from the side of the plate 7. Specifically, one protruded member 9a is provided on one surface side (the front surface side) of the plate 7, and the other protruded member 9b is provided on the other surface side (the rear surface side) of the plate 7. In accordance with this embodiment, pairs of the protruded members are respectively provided on the upper portion, the central portion and the bottom portion of the right and left edge portions of the plate 7. A protruded portion serving as an engagement portion 10 for engaging with the right and left end portions of the net 6 is provided at each of the distal end portions of the protruded members 9a, 9b.

The roof 2 is made of a net member with a substantially rectangular or square configuration as seen from above. One end and the other end of the roof 2 are bent downward so as to be connected along the upper end portion of the side wall 1. The roof 2 has a grip portion 2a at its top center.

In this way, the cage main body 3 formed of the side wall 1 and the roof 2 is made into a box shape with its bottom portion being opened (without a bottom wall).

The mount 4 is formed in a substantially rectangular or square configuration as seen from above. Two steps 11, 12 are formed in this order at the side wall of the mount 4 so that its capacity is gradually reduced.

The lower end portion of the cage main body 3 (side wall 1) is placed on the upper step 11. In order to prevent the placed cage main body 3 (side wall 1) from being removed from the step 11, a plurality of removal preventing pieces 13, 13 . . . are formed at appropriate positions on the upper portion of the side wall of the mount 4.

An opening 14 is formed at one surface of the side wall of the mount 4. A tray 15 is provided in the opening 14 so as to be taken out from or to be pushed into the mount 4.

The bottom net 5 is a substantially rectangular or square shaped net member and accommodated within the mount 4 with its peripheral edge abutting the top surface of the step 12.

Next, a method for assembling the cage D with the above described structure will be described.

In order to assemble the cage D, the following operations (1) to (4) may be performed.

Firstly, (1) the bottom net 5 is placed on the step 12 of the mount 4. Then, (2) the nets 6, 6 and the plates 7, 7 are connected together in order to form the side wall 1. The nets 6 and the plates 7 can be connected together by inserting the right and left end portions of the nets 6 into the joint portions 9 formed at the right and left end portions of the plates 7. As a result, the right and left end portions of the nets 6 can be connected to the plates 7 so that the net 6 forms an angle of 180° with the plate 7.

Subsequently, (3) the lower end portion of the side wall 1 formed as described above is placed on the top surface of the step 11 of the mount 4, and the removal preventing pieces 13, 13 . . . are engaged with the lower end portion of the side wall 1. Finally, (4) the roof 2 is connected to the upper end portion of the side wall 1. In this way, the cage D is assembled. The side wall 1 can be connected to the roof 2 by engaging the engagement devices 8, 8 . . . formed at the upper end portion of the side wall 1 with the peripheral edge portion of the roof 2.

The cage D may not be assembled in the order of operations (1), (2), (3) and (4). This order may be appropriately changed.

In accordance with the cage D with the above-described structure, that portion of the side wall 1 that needs to be bent (or curved) by a predetermined angle is provided only in the nets 6, 6. Further, in the state that the net 6 is connected to the plate 7, the right and left end portions of the net 6 are substantially flush with the right and left end portions of the plate 7. Thus, it is possible to mount the nets 6, 6 and the plates 7, 7 to the mount 4 relatively easily while the nets and plates are held by the hand so that the angle formed by them is not changed. As a result, the cage D can be assembled rapidly and simply.

Further, according to the cage D, instead of directly connecting the nets 6, 6 together, the nets 6, 6 are connected together via the plates 7, 7. The width of the short rectangular portions 6b, 6b of the net 6 with substantially U-shaped configuration as seen from above can be reduced. For this reason, the nets 6, 6 are not bulky. Thus, the cage can be disassembled in a compact manner when it is transported or put away.

Moreover, in accordance with the cage D, the plates 7, 7 are formed so as to be substantially transparent. Thus, the interior of the cage D can be seen even further clearly through the plates 7, 7 as compared to the case of seeing through meshes of the nets 6, 6. As a result, the state of objects to be raised within the cage D (e.g., animals) can be known more precisely.

In the cage D of this embodiment, the net 6 has vertically long meshes. Nevertheless, the present invention is not limited to such configuration. The net may have horizontally long meshes or may have meshes that the vertical width is substantially the same as the horizontal width.

The cage D of this embodiment is configured so that the cage main body 3 is formed in a substantially rectangular parallelepiped or cubic shaped box without a bottom. Nevertheless, the present invention is not limited to such configuration. For example, the cage may be formed in a polygonal columnar shaped box without a bottom. Further, that portion of the cage main body 3 that corresponds to the portion above the plate 7 may be formed in a dome shape or a quadrangular pyramid shape.

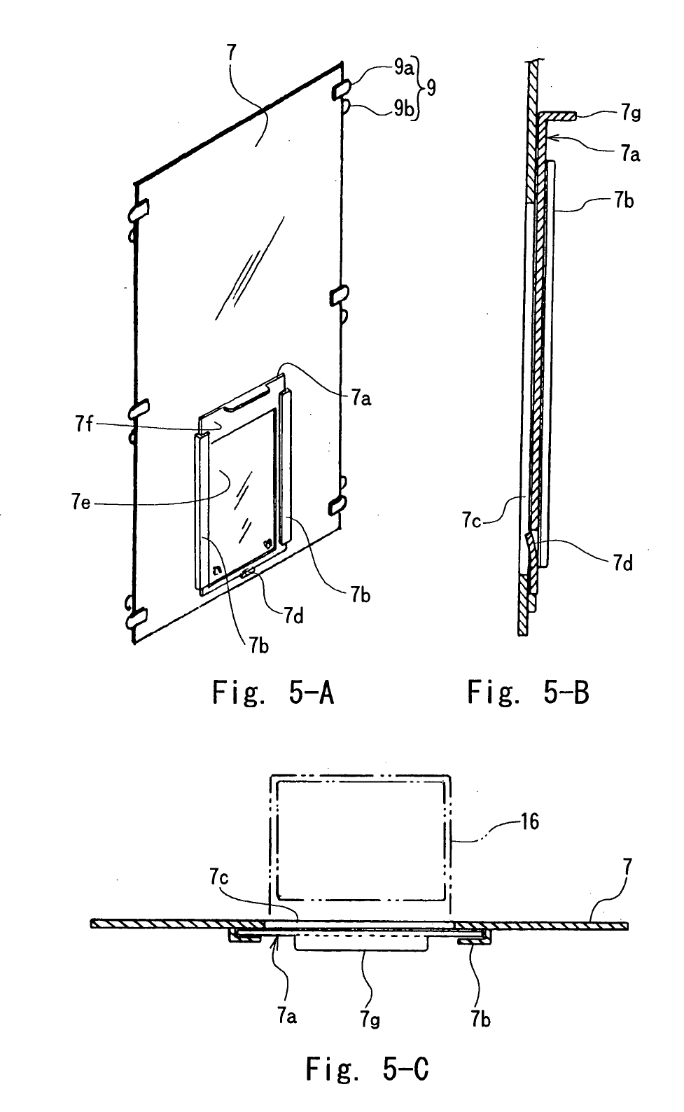

FIG. 5A is a perspective view schematically illustrating the structure of modified example of the plate 7. FIG. 5B is a vertical sectional view schematically illustrating the structure of the modified example of the plate 7. FIG. 5C is an explanatory view schematically illustrating the structure of the modified example of the plate 7.

In accordance with the cage D of the above-described embodiment, the doors 6c that can be freely opened or closed are provided on the net 6. Thus, unillustrated containers for feed and water may be placed at positions corresponding to innersides of the doors 6c. The doors 6c may be opened and the feed and water can be supplied within the containers. In this way, objects to be raised within the cage D can be raised. For example, assume that a bird is raised within the cage D. If this bird flutters, the feed and water in the containers may be spread around the cage D through meshes of the net 6 by the wind generated by fluttering.

In order to prevent such spreading, as shown in FIGS. 5A to 5C, a freely opened or closed door 7a is provided on the plate 7. The container 16 for feed or water may be placed at the position corresponding to the inside of the door 7a.

The door 7a is vertically slid along guides 7b, 7b provided at the plate 7. An opening 7c is formed at the plate 7 between the guides 7b, 7b. An engagement portion 7d for preventing falling of the door 7a is provided below the opening 7c.

The door 7a includes a transparent plate portion 7e and a frame portion 7f for holding the peripheral edge of the plate portion 7e. A grip portion 7g is provided at the top of the frame portion 7f. The door 7a is not limited to such configuration.

As described above, in the case of providing the door 7a at the plate 7 and placing the container 16 for feed or water at the position corresponding to the inside of the door 7a, for example, when a bird is raised within the cage D and this bird flutters, the feed or water within the container cannot be spread around the cage D through meshes of the net 6 because of a wind generated by fluttering. The feed or water may spread within the cage D.

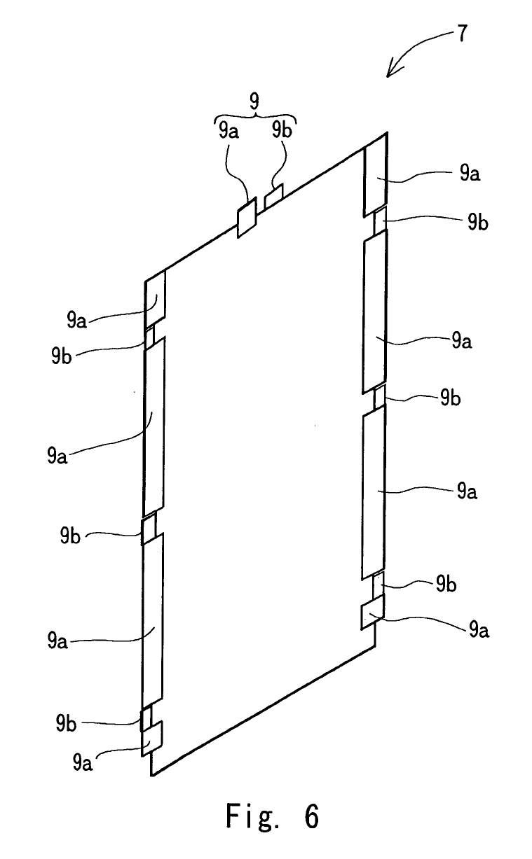

Although the joint portions 9 are provided only at the right and left edge portions of the plate 7 in the embodiment illustrated in FIGS. 1 to 5, the present invention is not limited to such configuration. For example, as illustrated in FIG. 6, the joint portion 9 may be provided at the upper edge portion of the plate 7. The plate 7 may be connected to the roof 2 by this joint portion 9 provided at the upper edge portion of the plate 7.

A plurality of protruded members 9a, 9b may not have the substantially same length, and may have appropriate lengths. For example, as illustrated in FIG. 6, four protruded members 9a, 9a may be provided at each of the right and left edge portions of the plate 7. The top and bottom protruded members 9a, 9a may be shorter than two protruded members 9a, 9a provided at the central portion.

As described above, in accordance with the present invention with the above-described structure, it is possible to provide a cage which can be easily assembled and disassembled in a compact manner.

In accordance with the above-described cage D, that portion of the side wall 1 that needs to be bent (or curved) by a predetermined angle is provided only at the nets 6, 6. In the state that the net 6 is connected to the plate 7, the right and left end portions of the net 6 and the right and left end portions of the plate 7 are substantially flush with each other. Thus, it is possible to mount the nets 6, 6 and the plates 7, 7 to the mount 4 relatively easily while the nets and plates are held by the hand so that the angle formed by them is not changed. Accordingly, the cage D can be assembled rapidly and easily.

Further, in accordance with the cage D, instead of directly connecting the nets 6, 6 together, the nets 6, 6 are connected via the plates 7, 7. The width of the short rectangular portions 6b, 6b of the net 6 with the substantially U-shaped configuration as seen from above may be reduced. Thus, the nets 6, 6 are not bulky and the cage can be disassembled in a compact manner when it is transported or put away.

What is claimed is:

1. A cage, which comprises a cage main body having a side wall and a roof and a mount for supporting the cage main body, characterized by being constituted in such that the side wall includes a plurality of nets with a bent or curved portion and a plurality of plates with their right and left end portions connected to the right and left end portions of the nets, and the right and left end portions of the connected nets are substantially flush with the right and left end portions of the plates.

2. The cage according to claim 1 wherein the plate is formed of materials with light transmitting property.

3. The cage according to claim 1 or 2 wherein two nets are provided and each of them is formed in a substantially U-shaped configuration as seen from above.
